(19) United States
(12) Patent Application Publication
(10) Pub. No.: US 2009/0232618 A1
(43) Pub. Date: Sep. 17, 2009

(54) FASTENER ASSEMBLY

(75) Inventor: Justin R. Ballenger, Easley, SC (US)

Correspondence Address: MICHAEL BEST & FRIEDRICH LLP, 100 E WISCONSIN AVENUE, Suite 3300, MILWAUKEE, WI, 53202, US

(73) Assignee: The Timken Company, Canton, OH (US)

(21) Appl. No.: 12/361,973

(22) Filed: Jan. 29, 2009

Related U.S. Application Data
(60) Provisional application No. 61/036,309, filed on Mar. 13, 2008.

(51) Int. Cl. F16B 43/00; F16B 39/28; B23P 11/00

(52) U.S. Cl. 411/371.2; 411/133; 29/283.5

(57) ABSTRACT

A fastener assembly includes a fastener having a head and a shank, with a necked portion, extending from the head. The fastener assembly also includes a retainer having an aperture through which the shank is inserted and at least one radially inwardly-projecting tang engaged with the necked portion of the shank to limit movement of the retainer along the shank to within the necked portion.

### RELATED APPLICATIONS

This application claims priority to U.S. Provisional Patent Application Ser. No. 61/036,309 filed on Mar. 13, 2008, the entire content of which is incorporated herein by reference.

### FIELD OF THE INVENTION

The present invention relates to fasteners.

### BACKGROUND OF THE INVENTION

When securing components with fasteners, the fasteners are typically provided separately from the components themselves and must be brought to the components using either an automated or manual process during assembly of the components. For example, when securing two components by a bolt, the two components are often first brought together in their final assembled positions, the bolt is then brought to the pre-assembled components, and lastly the bolt is inserted through respective apertures in the components and tightened to secure the components together.

### SUMMARY OF THE INVENTION

Unitizing fasteners with one or more of the components which the fasteners will secure can reduce the number of steps required to assemble the components and subsequently decrease the amount of time spent on the component assembly.

The present invention provides, in one aspect, a fastener assembly including a fastener having a head and a shank extending from the head. The shank has a necked portion. The fastener assembly also includes a retainer having an aperture through which the shank is inserted and at least one radially inwardly-projecting tang engaged with the necked portion of the shank to limit movement of the retainer along the shank to within the necked portion.

The present invention provides, in another aspect, a unitized engine component assembly including an engine component having an aperture and a lip projecting into the aperture, and a fastener including a head and a shank extending from the head. The shank has a necked portion. The unitized engine component assembly also includes a retainer positioned in the aperture of the engine component. The retainer includes an aperture through which the shank is inserted and at least one radially inwardly-projecting tang engaged with the necked portion of the shank to limit movement of the retainer along the shank to within the necked portion. Engagement of the retainer and the lip substantially prevents removal of the shank from the engine component aperture.

The present invention provides, in yet another aspect, a method of unitizing a fastener and a component. The method includes providing the component with an aperture and a lip projecting into the aperture, providing the fastener with a shank and a necked portion on the shank, inserting the shank through an aperture in a retainer, deflecting a radially inwardly-projecting tang of the retainer upon inserting the shank through the retainer aperture, engaging the necked portion of the shank with the radially inwardly-projecting tang, inserting the retainer into the component aperture, and resiliently deforming the retainer upon moving the retainer past the lip.

Other features and aspects of the invention will become apparent by consideration of the following detailed description and accompanying drawings.

### BRIEF DESCRIPTION OF THE DRAWINGS

FIG. 1 is a top perspective view of a fastener assembly of the present invention, including a fastener and a retainer.

FIG. 2 is a bottom perspective view of the fastener assembly of FIG. 1.

FIG. 3 is an exploded, perspective view of the fastener and retainer of FIG. 1, before the retainer is positioned on the fastener.

FIG. 4 is a top view of the retainer shown in FIG. 3.

FIG. 5 is a partial cross-sectional view of the fastener assembly of FIG. 1, illustrating the retainer being positioned on the fastener.

FIG. 6 is a partial cross-sectional view of the fastener assembly of FIG. 1, illustrating the retainer engaging a necked portion of the retainer.

FIG. 7 is a partial cutaway view of an engine component configured to receive the fastener assembly of FIG. 1.

FIG. 8 is a partial cross-sectional view of the fastener assembly of FIG. 1 being coupled to the engine component.

FIG. 9 is a partial cross-sectional view of the fastener assembly of FIG. 1 unitized to the engine component, the fastener assembly being shown in a first position relative to the engine component.

FIG. 10 is a partial cross-sectional view of the fastener assembly of FIG. 1 unitized to the engine component, the fastener assembly being shown in a second position relative to the engine component.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

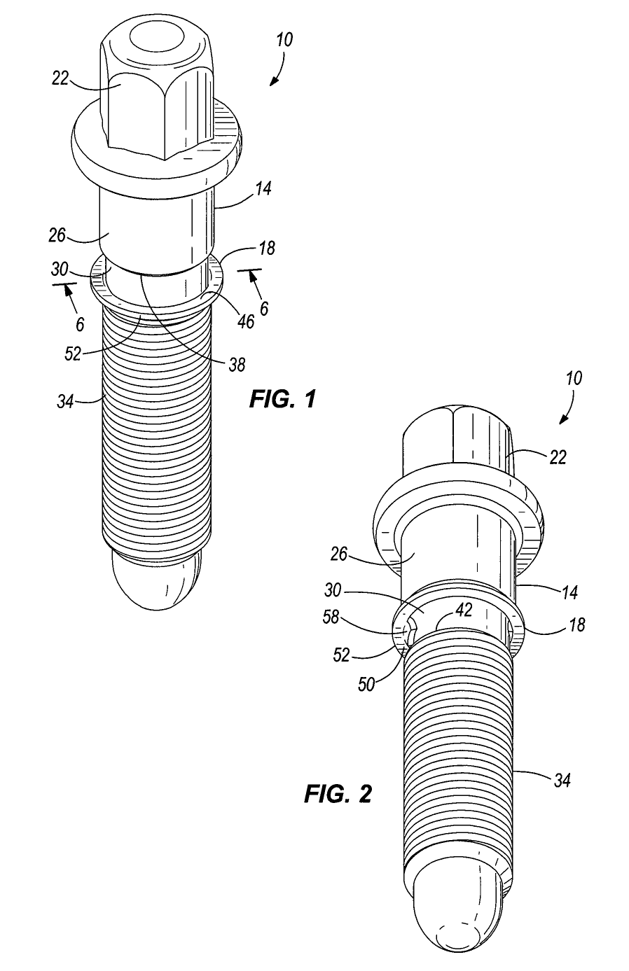

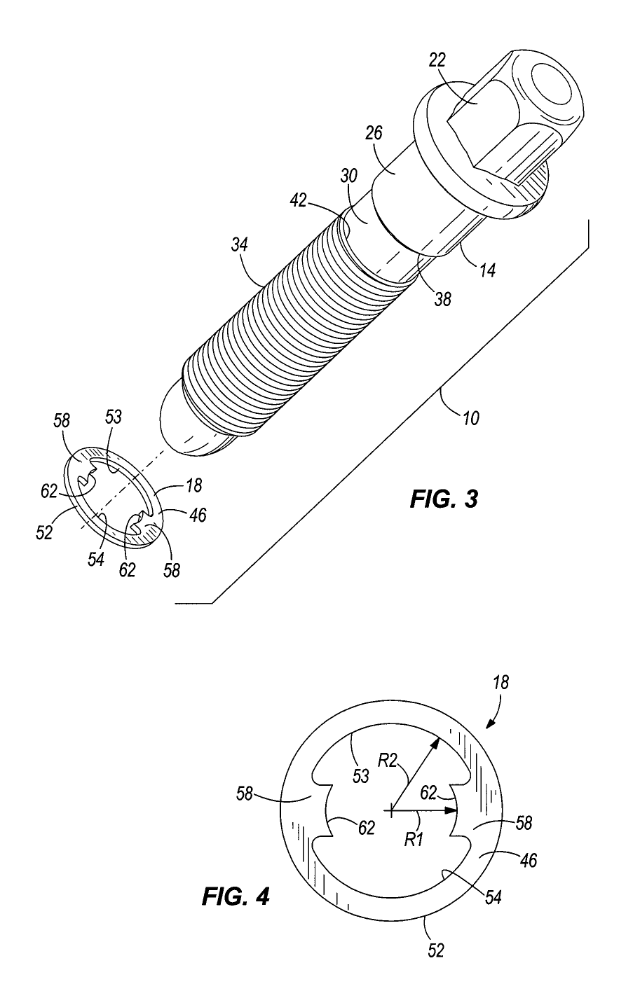

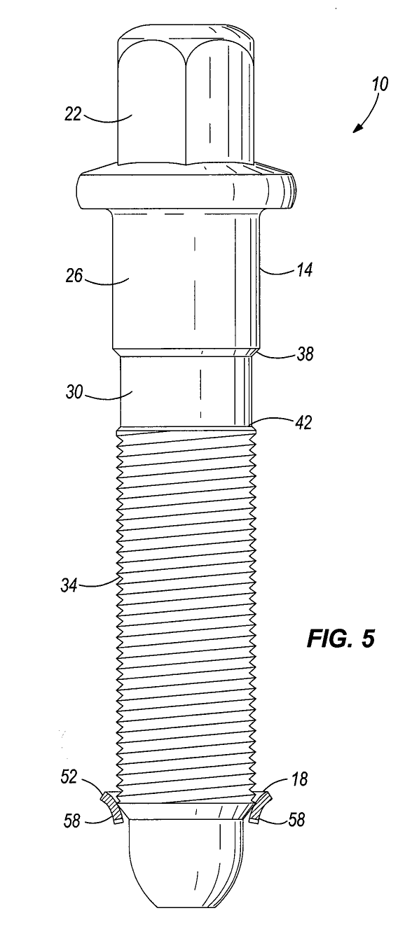

FIGS. 1 and 2 illustrate a fastener assembly 10 including a fastener 14 and a retainer 18 coupled to the fastener 14. The fastener 14 includes a head 22 and a shank 26 extending from the head 22. Although the illustrated fastener 14 is in the form of a bolt, the fastener 14 may be configured in any of a number of different ways. The shank 26 includes a non-threaded necked portion 30, having a reduced diameter relative to the portions of the shank 26 adjacent the necked portion 30, spaced from the head 22, and a threaded portion 34 adjacent the necked portion 30. Alternatively, the necked portion 30 of the shank 26 may be spaced from the threaded portion 34 of the shank 26. Further, the necked portion 30 of the shank 26 may be adjacent the head 22. As shown in FIG. 5, the necked portion 30 of the shank 26 is defined between an upper shoulder 38 on the shank 26 and a lower shoulder 42 on the shank 26, which substantially coincides with the upper extent of the threaded portion 34. Alternatively, the lower shoulder 42 may be spaced from the threaded portion 34 as previously mentioned.

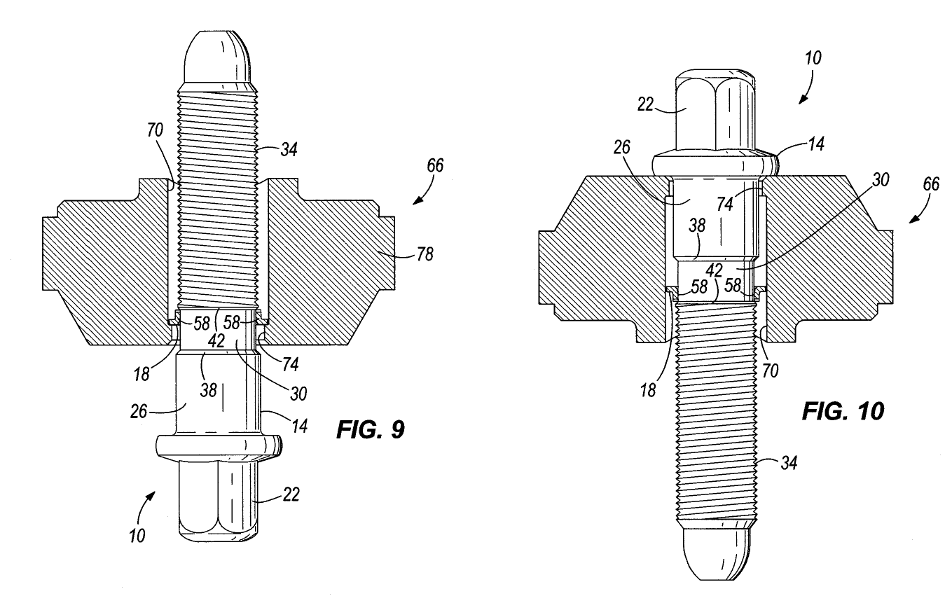

With reference to FIGS. 1-3, the retainer 18 is configured as a thin washer having substantially planar upper and lower surfaces 46, 50. The retainer 18 is made from a thin, resilient material capable of supporting the weight of the fastener 14 (see FIG. 9 and the accompanying discussion below). Any of a number of different plastic or metallic materials may be employed to function in this manner. As shown in FIG. 4, the retainer 18 includes a circular outer periphery 52 and a substantially circular inner periphery 53 defining an aperture 54. The retainer 18 also includes one or more radially inwardly-projecting tangs 58. Although the illustrated retainer 18 includes two opposed tangs 58, the retainer 18 may alternatively be configured with one or more than two tangs 58. For example, the retainer 18 may be configured with three tangs 58 spaced equally from each along the inner periphery 53. Likewise, four, five, six, etc. tangs 58 could be employed on the retainer 18 in a similar manner.

With reference to FIGS. 3 and 4, each of the tangs 58 includes an arcuate edge 62 configured to engage the shank 26. The ratio of the radius (R1) defining the arcuate edge 62 of each of the tangs 58 to the radius (R2) defining the inner periphery 53 of the retainer 18 is about 0.75:1. Alternatively, this ratio (i.e., R1/R2) may be customized to the particular fastener to which the retainer 18 will be coupled or to suit the material used for the retainer 18. As a further alternative, each of the tangs 58 may include a “V”-shaped edge, a substantially flat edge, or any of a number of differently-configured edges or surfaces, configured to engage the necked portion 30 of the shank 26.

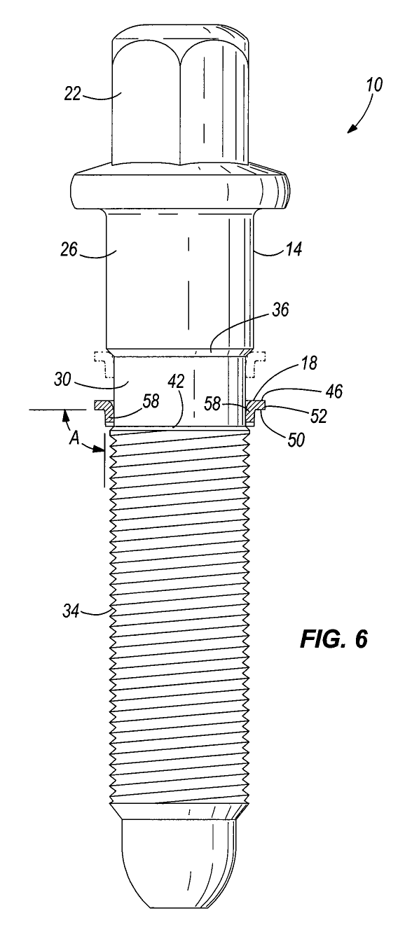

With reference to FIGS. 5 and 6, the steps employed to couple the retainer 18 to the fastener 14 are shown. As shown in FIG. 5, the retainer 18 is aligned with the shank 26 and the bottom of the shank 26 is initially inserted through the aperture 54. Upon contact between the tangs 58 and the threaded portion 34 of the shank 26, continued displacement of the shank 26 causes the retainer 18, particularly the tangs 58, to resiliently deform to allow the retainer 18 to slide relative to the threaded portion 34 toward the head 22.

Upon reaching the lower shoulder 42 of the necked portion 30, the retainer 18 at least partially rebounds towards its undeflected shape, however, the tangs 58 may remain at least partially deflected from their co-planar orientation shown in FIGS. 3 and 4 to engage the necked portion 30 of the shank 26. In the illustrated construction of the retainer 18 in FIG. 6, each of the tangs 58 is substantially perpendicular to the upper and lower surfaces 46, 50 of the retainer 18. Specifically, each of the tangs 58 forms an included angle A with the lower surface 50 of about 90 degrees. Depending upon the particular configurations of the fastener 14 and the retainer 18, each of the tangs 58 may form an included angle A with the lower surface 50 greater than about 90 degrees (e.g., the tangs 58 may be allowed to substantially resume their undeflected shape to yield an included angle A of about 180 degrees). The fastener 14 and the retainer 18 may have any of a number of different configurations provided that the outer diameter of the necked portion 30 is greater than or equal to twice the radius R1 of the arcuate edges 62, and equal to or less than twice the radius R2 of the aperture 54 (see FIG. 4).

As shown in FIG. 6, the retainer 18 is movable along the necked portion 30 between extreme positions, with the engagement of the tangs 58 and the lower shoulder 42 providing the lower-most limit to the movement of the retainer 18 relative to the shank 26, and the engagement of the tangs 58 or the upper surface 46 of the retainer 18 and the upper shoulder 38 providing the upper-most limit to the movement of the retainer 18 relative to the shank 26 (shown in phantom).

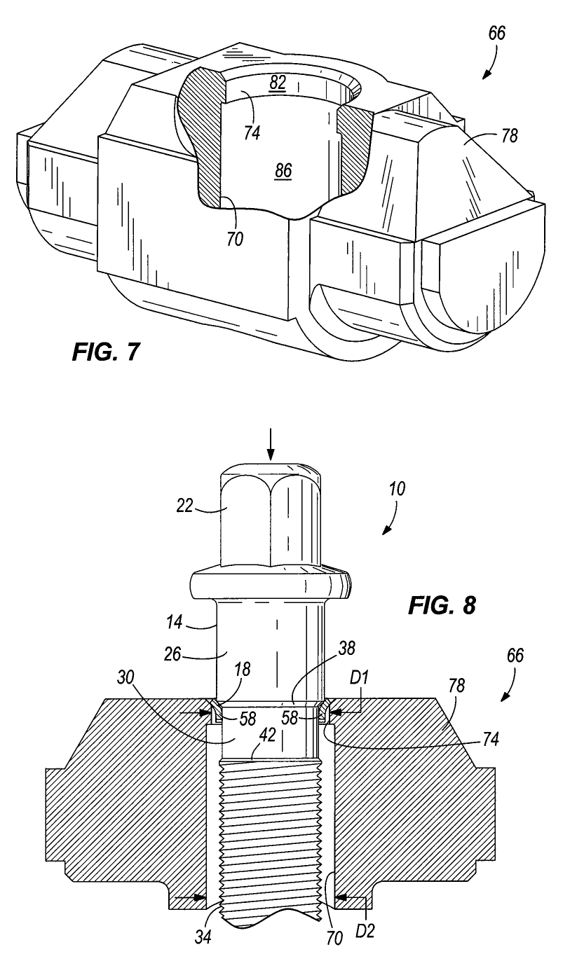

With reference to FIG. 7, an engine component 66 including an aperture 70 and a lip 74 projecting into the aperture 70 is shown. The illustrated engine component 66 is configured as a rocker arm pivot 78 of an engine valve train. Alternatively, the engine component 66 may be configured as any other component to be secured to the engine utilizing the fastener assembly 10 of FIGS. 1 and 2. As shown in FIG. 7, the lip 74 is positioned toward the upper end of the aperture 70. Alternatively, the lip 74 may be positioned toward the bottom end of the aperture 70, the middle of the aperture 70, or at any location along the depth of the aperture 70 or adjacent to the aperture 70. The illustrated lip 74 includes a circular inner periphery 82 defined by an inner diameter d1, and an inner peripheral surface 86 of the rocker arm pivot 78 defining the aperture 70 is defined by an inner diameter D2 (see FIG. 8). A ratio of the diameters of the inner periphery 82 of the lip 74 and the inner peripheral surface 86 of the rocker arm pivot 78 is about 0.9:1. Depending upon the particular configurations of the fastener 14 and the retainer 18, this ratio (i.e., D1/D2) maybe greater or less than about 0.9:1. In other embodiments, the lip need not be annular, but may be a non-annular projection extending radially inwardly from the surface 86.

To unitize the fastener 14 and the rocker arm pivot 78, the shank 26 is initially aligned with the aperture 70 in the rocker arm pivot 78 and inserted into the aperture 70. The retainer 18 is initially situated on the shank 26 such that the tangs 58 engage the lower shoulder 42 of the necked portion 70. Upon contact between the lip 74 and the retainer 18, continued insertion of the shank 26 into the aperture 70 in the rocker arm pivot 78 causes the retainer 18 to slide upwardly, relative to and within the necked portion 30 of the shank 26, until the tangs 58 and/or the upper surface 46 engage the upper shoulder 38 of the necked portion 30. From this point, continued insertion of the shank 26 into the rocker arm pivot 78 causes the retainer 18 to resiliently deflect or bow due to the obstruction caused by the lip (see FIG. 8), until the deflection of the retainer is sufficient to allow the retainer to move past the lip 74, at which time the retainer 18 (with the exception of the tangs 58) rebounds or substantially resumes its undeflected shape (see FIGS. 9 and 10). Although FIGS. 9 and 10 illustrate the fastener assembly 10 installed on the rocker arm pivot 78, the rocker arm pivot 78 may alternatively first be pre-assembled with the rocker arm itself (not shown) before the fastener assembly is installed on the rocker arm pivot 78.

The retainer 18 facilitates handling of the fastener 14 and the rocker arm pivot 78 as a unit, without substantial concern that the fastener 14 and the rocker arm pivot 78 may become unintentionally separated. For example, FIGS. 9 and 10 illustrate the retention of the fastener 14 to the rocker arm pivot 78 while the rocker arm pivot 78 is situated in an inverted orientation and a non-inverted orientation, respectively. When the rocker arm pivot 78 is handled in an inverted orientation (FIG. 9), the retainer 18 is abutted or engaged with the lip 74, and the tangs 58 are engaged with the lower shoulder 42 of the necked portion 30, such that the fastener 14 is supported by the rocker arm pivot 78 via the retainer 18. When the rocker arm pivot 78 is handled in a non-inverted or upright orientation (FIG. 10), the head 22 of the fastener 14 is directly supported on the rocker arm pivot 78. As a result, the movement of the fastener 14 relative to the rocker arm pivot 78 is constrained between a first extreme position, in which the retainer 18 and the lip 74 are engaged (FIG. 9), and a second extreme position, in which the head 22 of the fastener 14 is directly supported on or engaged with the rocker arm pivot 78 (FIG. 10).

Various features of the invention are set forth in the following claims.

What is claimed is:

1. A fastener assembly comprising:
a fastener including a head and a shank extending from the head, the shank having a necked portion;
a retainer including
an aperture through which the shank is inserted; and
at least one radially inwardly-projecting tang engaged with the necked portion of the shank to limit movement of the retainer along the shank to within the necked portion.

2. The fastener assembly of claim 1, wherein the shank includes a threaded portion, and wherein the necked portion is adjacent the threaded portion.

3. The fastener assembly of claim 2, wherein movement of the retainer along the shank in at least one direction is limited by the threaded portion.

4. The fastener assembly of claim 1, wherein the at least one radially inwardly-projecting tang includes a pair of opposed radially inwardly-projecting tangs engaged with the necked portion of the shank.

5. The fastener assembly of claim 4, wherein each of the opposed radially inwardly-projecting tangs includes an arcuate edge engaged with the necked portion of the shank, and wherein a ratio of the radius of the arcuate edge of each of the tangs to the radius of an inner periphery of the aperture is about 0.75:1.

6. The fastener assembly of claim 4, wherein each of the opposed radially inwardly-projecting tangs includes an arcuate edge engaged with the necked portion of the shank, wherein the outer diameter of the necked portion is greater than or substantially equal to twice a radius of the arcuate edges, and wherein the outer diameter of the necked portion is substantially equal to or less than twice a radius of an outer periphery of the aperture.

7. The fastener assembly of claim 1, wherein the retainer includes an upper surface defining a plane, and wherein the radially inwardly-projecting tang is obliquely oriented relative to the plane.

8. The fastener assembly of claim 1, wherein the retainer includes a circular outer periphery.

9. The fastener assembly of claim 1, wherein the at least one radially inwardly-projecting tang includes an arcuate edge engaged with the necked portion of the shank.

10. A unitized engine component assembly comprising:
an engine component including an aperture and a lip projecting into the aperture;
a fastener including a head and a shank extending from the head, the shank having a necked portion;
a retainer positioned in the aperture of the engine component, the retainer including
an aperture through which the shank is inserted; and
at least one radially inwardly-projecting tang engaged with the necked portion of the shank to limit movement of the retainer along the shank to within the necked portion;
wherein engagement of the retainer and the lip substantially prevents removal of the shank from the engine component aperture.

11. The unitized engine component assembly of claim 10, wherein the shank includes a threaded portion, and wherein the necked portion is adjacent the threaded portion.

12. The unitized engine component assembly of claim 11, wherein movement of the retainer along the shank in at least one direction is limited by the threaded portion.

13. The unitized engine component assembly of claim 10, wherein the at least one radially inwardly-projecting tang includes a pair of opposed radially inwardly-projecting tangs engaged with the necked portion of the shank.

14. The unitized engine component assembly of claim 13, wherein each of the opposed radially inwardly-projecting tangs includes an arcuate edge engaged with the necked portion of the shank, and wherein a ratio of the radius of the arcuate edge of each of the tangs to the radius of an inner periphery of the aperture is about 0.75:1.

15. The unitized engine component assembly of claim 13, wherein each of the opposed radially inwardly-projecting tangs includes an arcuate edge engaged with the necked portion of the shank, wherein the outer diameter of the necked portion is greater than or substantially equal to twice a radius of the arcuate edges, and wherein the outer diameter of the necked portion is substantially equal to or less than twice a radius of an outer periphery of the aperture.

16. The unitized engine component assembly of claim 10, wherein the retainer includes an upper surface defining a plane, and wherein the radially inwardly-projecting tang is obliquely oriented relative to the plane.

17. The unitized engine component assembly of claim 10, wherein the retainer includes a circular outer periphery, and wherein the lip includes a circular inner periphery.

18. The unitized engine component assembly of claim 10, wherein the fastener is axially movable relative to the engine component between a first position, in which the retainer is engaged with the lip to prevent removal of the shank from the engine component aperture, and a second position, in which the head is engaged with the engine component.

19. The unitized engine component assembly of claim 10, wherein the engine component is a rocker arm pivot of an engine valve train.

20. A method of unitizing a fastener and a component, the method comprising:
providing the component with an aperture and a lip projecting into the aperture;
providing the fastener with a shank and a necked portion on the shank;
inserting the shank through an aperture in a retainer;
deflecting a radially inwardly-projecting tang of the retainer upon inserting the shank through the retainer aperture;
engaging the necked portion of the shank with the radially inwardly-projecting tang;
inserting the retainer into the component aperture; and
resiliently deforming the retainer upon moving the retainer past the lip.

21. The method of claim 19, further comprising allowing the retainer to at least partially resume its undeformed shape after moving the retainer past the lip.
